(19) United States
(12) Patent Application Publication
(10) Pub. No.: US 2004/0121128 A1
(43) Pub. Date: Jun. 24, 2004

(54) Structural improvement of an injection molded blade

(76) Inventor: Tser-Wen Chou, Taipei (TW)

Correspondence Address: RABIN & BERDO, P.C., Suite 500, 1101 14th Street, N.W., Washington, DC, 20005, US

(21) Appl. No.: 10/321,619

(22) Filed: Dec. 18, 2002

(51) Int. Cl. B32B 3/20

(52) U.S. Cl. 428/188

(57) ABSTRACT

An improved injection molded blade, particularly made of PVC foam and used for Venetian blinds, door or window ventilators, air conditioner air outlets, involving mainly a plurality of longitudinal or latitudinal partition plates installed in a discharge mold of an injection molder, so the material is subjected to heat treatment by the inside wall of the mold outlet and the partition plates, and when the blade passes the discharge outlet, there are a plurality of rigid and solid ribs formed inside the blade and on an exterior periphery of the blade, thereby achieving the effects of more solid, durable and beautiful structure than conventional blades. Optionally an additional small mold is installed inside the discharge mold of the injection molder, filled with fiberglass or other materials different from that of the blade, so that the finished blade will incorporate a layer of composite materials for better strength, solidarity and durability.

### BACKGROUND OF THE INVENTION

(a) Field of the Invention

The present invention relates to a structural improvement of an injection molded blade, particularly a PVC foam blade that is suitable for applications to Venetian blinds, door and window ventilators and air conditioner air outlets, involving mainly a plurality of longitudinal or latitudinal partition plates installed inside a discharge mold of an injection molder, and optionally a mold with a smaller area inside the mold, so that a finished blade has a structure of rigid and solid ribs on the exterior periphery and inside of the blade, and optionally the incorporation of a layer of composite materials inside the blade, thereby achieving the effects of more solidarity, durability and beautiful structure.

(b) Description of the Prior Art

PVC foam materials are widely used by the industry in recent years for applications to Venetian blinds, door and window ventilators, air conditioner air outlets, etc. Because of its low costs and easy production, it has come to replace conventional use of wood boards, wood dust condensed boards, aluminum boards, etc.

The PVC foam blade A in current use has a construction shown in FIGS. 1 and 2. PVC foam material is heated to become a fused status, which is squeezed out of an injection molder discharge outlet to make an elongated blade with specified width and thickness. Then it is cut into a plurality of blades in desired specifications. During its production, the discharge mold has a higher heat than the injection molder itself, so that when the exterior periphery of the blade is subjected to further heating when the blade is extruded. When it is cooled to form, there is a formation of a surface layer B on the exterior periphery of the blade that is more rigid than inside material. So the surface layer B looks beautiful and neat, and has a better strength. However, in actual use, the blade A in various applications is cut to different lengths to withstand various outside force in various circumstances. For example, when it is used as a blade for a Venetian blind, the blade must be long enough if it is made wider. Then, an elongated blade is easily bent down due to gravitational force, resulting in deformation and poor appearance. The longer the blade, the weaker its structural strength; that means frequent breaking and deforming, and room for improvement.

To seek possible improvement, the inventor has devoted in the research, based on many years working experience in research and development and production of related blade products, and has come up with the present invention of blade having a plurality of solid and rigid ribs inside the blade and on the exterior periphery of the blade, and optionally the incorporation of a layer of composite materials inside the blade, to achieve the effects of better solidarity, durability and beauty.

To enable better understanding of the structural characteristics and performance of the present invention, please refer to the drawings and detailed description below.

### BRIEF DESCRIPTION OF DRAWINGS

FIG. 1 is an exterior view of a prior art of blade made by a conventional injection molder.

FIG. 2 is a section view of the prior art of blade.

FIG. 3 is a section view of a discharge mold (having longitudinal partition plates inside) of an injection molder in line with the present invention.

FIG. 4 is a section view of a discharge mold (having latitudinal partition plates inside) of an injection molder in line with the present invention.

FIG. 5 is a section view of the invention of blade (having longitudinal ribs inside).

FIG. 6 is an exterior view of the invention of blade (having longitudinal ribs inside).

FIG. 7 is a section view of the invention of blade (having latitudinal ribs inside).

FIG. 8 is an exterior view of the invention of blade (having latitudinal ribs inside).

FIG. 9 is a view of preferred embodiment of the invention of blade with a composite material layer coated inside the invention of blade.

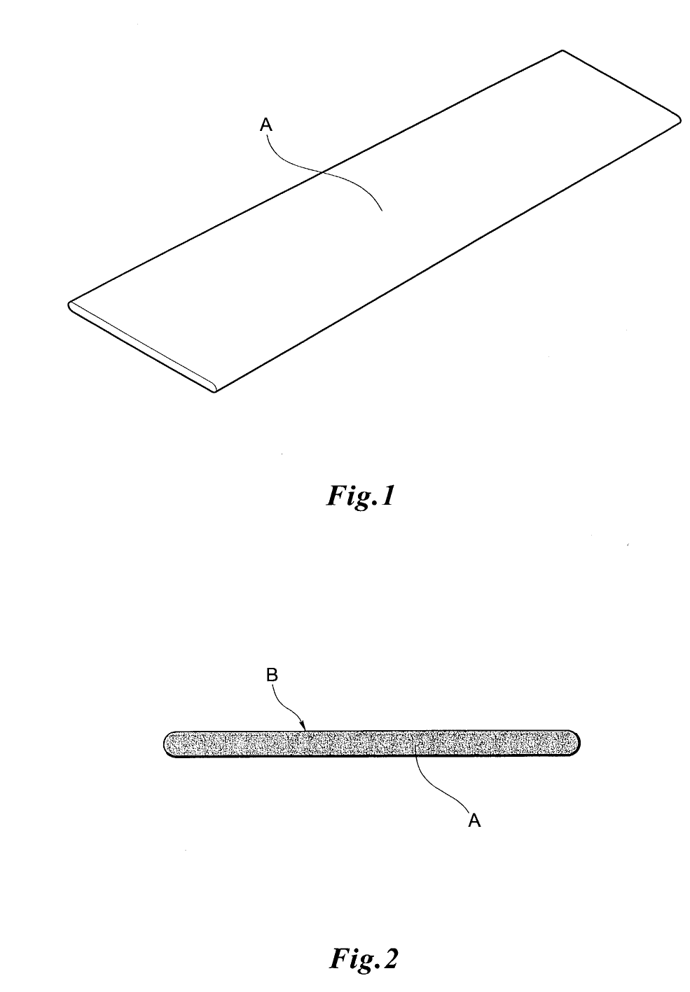

| | |
|---|---|
| 10 blade | 13 composite material layer |
| 11 exterior periphery | 20 mold |
| 12 rib | 21 partition plate |

### DETAILED DESCRIPTION OF PREFERRED EMBODIMENTS

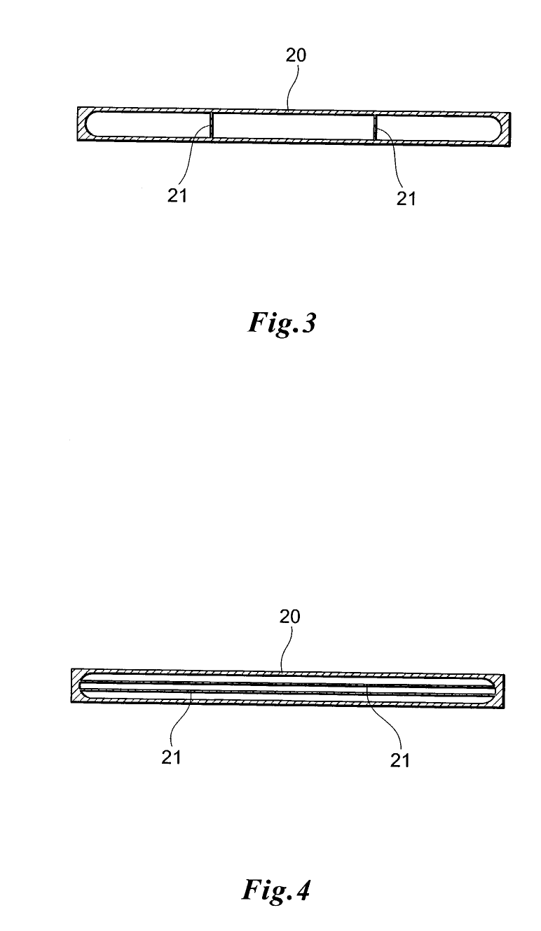

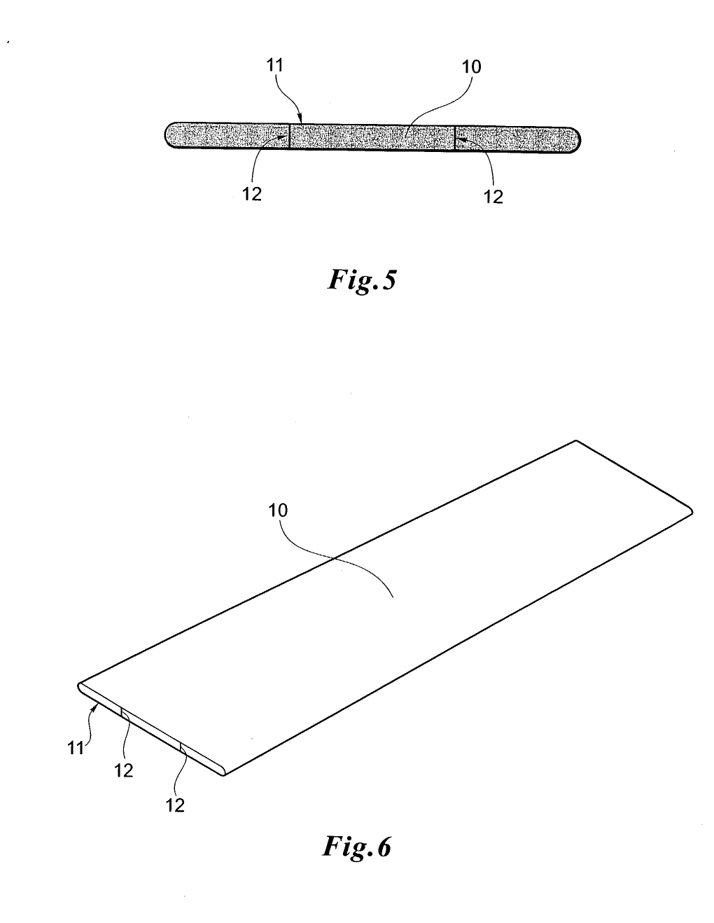

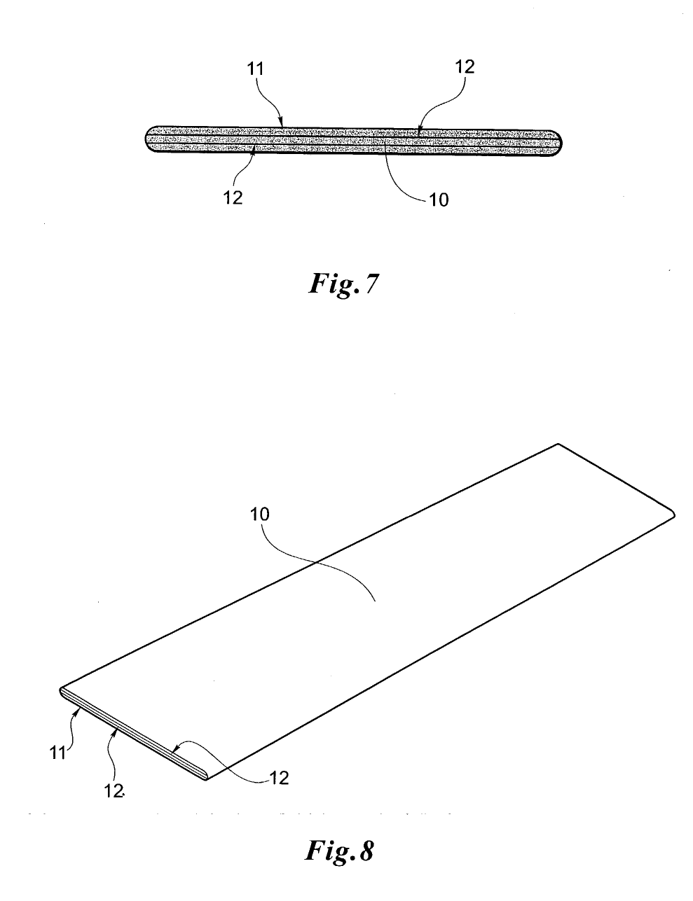

Please refer to FIGS. 3 and 4; an injection molder discharge mold 20 working with the present invention comprises a mold frame and a plurality of partition plates 21 installed in longitudinal or latitudinal arrangement at specified positions inside the mold 20. So, when PVC foam material for the production of blade 10 is injected into a hopper of the injection molder, heated into a fused status in its passage through the mold 20 at a molder discharge, the fused material will be subjected to heat treatment at a higher temperature by an inside wall of the mold 20 and the partition plates 21; meanwhile, the fused material will be cut by the partition plates 21 to become separated pieces. FIGS. 3 and 4 illustrate a preferred embodiment of two longitudinal or latitudinal partition plates 21. So the fused material is cut into three pieces in longitudinal or latitudinal arrangement. The outlet at the front of the discharge of mold 20 is made to shrink slightly in size, so when the cut and heat-treated fused material passing through the shrunk outlet, three separate pieces are compressed and fused again to become one solid plate that is then cooled to a fixed form after being discharged from the molder, as shown in FIGS. 5, 6 or 7, 8. An exterior periphery 11 of the blade 10 and the cut and heat-treated portion inside the plate becomes a transverse rib 12 of more rigid and solid structure than other portions of the plate body, thereby the entire plate structure is reinforced. When the plate is cut into a blade 10 of any length and used for various applications, the blade 10 has the effects of more beautiful appearance and better durability than the conventional types of blade. Therefore, the strength of the invention of blade 10 can be reinforced by increasing the number of partition plates 21 in the discharge mold 20 to suit the purpose in different applications.

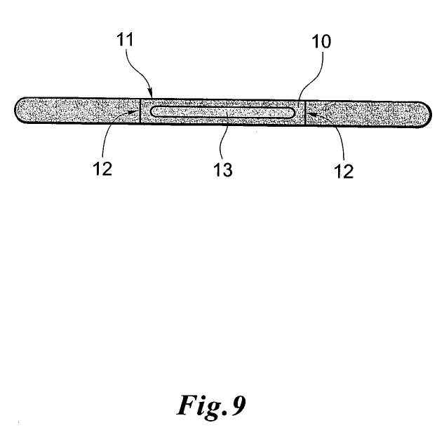

Optionally there is a mold of a smaller area installed inside the invention of discharge mold 20. This small mold serves to extrude various types of materials (such as fiberglass), so after the blade 10 is extruded to form, as shown in FIG. 9, a material layer 13 of different fiber materials is coated in a specified position inside the plate, in addition to the PVC foam material, the solid exterior periphery 11 and the reinforcing rib 12, forming a composite material structure. Thereby the entire structural strength of the blade 10 can be enhanced.

To sum up, the present invention has involved sophisticated structure, with structural design of a discharge mold in the injection molder, so that the formed blade has multiple lines of solid and rigid ribs inside the blade, in addition to its exterior periphery, or optionally there is a material layer of composite materials inside the blade to enable more rigid, durable and beautiful effects that are superior to conventional products. Therefore, this application is duly filed for a patent right. Your favorable consideration shall be appreciated.

What is claimed is:

1. A structural improvement of injection molded blade, involving a plurality of longitudinal or latitudinal partition plates installed inside a discharge mold of an injection molder, so designed that fused materials for the production of blade is properly cut and heat treated when the material passes the mold, then the fused material is compressed and fused again to become a solid plate, forming a plurality of longitudinal or latitudinal solid and rigid ribs inside the plate body and an exterior periphery of the plate.

2. The structural improvement of blade of claim 1, wherein there is optionally a mold of a smaller area installed inside the discharge mold of the injection molder, to extrude materials that are different from that of the blade, so that the blade incorporates a layer of composite materials when the blade is extruded to form.
